(19) United States
(12) Patent Application Publication
(10) Pub. No.: US 2023/0055884 A1
(43) Pub. Date: Feb. 23, 2023

(54) COMPOSITION COMPRISING A HEMIPEROXYACETAL, METHOD FOR POLYMERIZING SAME, USE THEREOF, AND COMPOSITION MATERIAL OBTAINED UPON POLYMERIZATION OF THE COMPOSITION

(71) Applicant: ARKEMA FRANCE, Colombes (FR)

(72) Inventors: Gilles FRANCOIS, PIERRE-BENITE CEDEX (FR); Bruno VAN HEMELRYCK, PIERRE-BENITE CEDEX (FR)

(21) Appl. No.: 17/783,145

(22) PCT Filed: Dec. 18, 2020
(86) PCT No.: PCT/FR2020/052571

§ 371 Date: Jun. 7, 2022

(30) Foreign Application Priority Data
Dec. 18, 2019 (FR) FR1914808

(51) Int. Cl. C08F 265/06; C08K 3/36

(52) U.S. Cl. CPC C08F 265/06; C08K 3/36

(57) ABSTRACT

The present invention relates to a composition comprising at least one (meth)acrylic monomer, optionally at least one (meth)acrylic copolymer and at least one organic peroxide chosen from hemiperoxyacetals. The invention also relates to the use of said at least one organic peroxide for the polymerization of a composition comprising at least one acrylic monomer and optionally at least one acrylic copolymer, to the use of the composition of the invention for the manufacture of resins, to a process for manufacturing thermoplastic, thermoset or composite parts, and also to the parts obtained themselves.

### FIELD OF THE INVENTION

The present invention relates to a composition comprising at least one (meth)acrylic monomer, optionally at least one (meth)acrylic polymer (in particular a (meth)acrylic copolymer), at least one organic peroxide chosen from hemiperoxyacetals and at least one additional organic peroxide.

The invention also relates to the use of at least one organic peroxide chosen from hemiperoxyacetals for the polymerization of a composition comprising at least one acrylic monomer and optionally at least one acrylic polymer (in particular an acrylic copolymer).

The invention also relates to the use of the composition as defined previously for manufacturing thermoplastic, thermoset or composite acrylic or methacrylic resins.

The present invention also relates to a process for manufacturing thermoplastic, thermoset or composite parts via the polymerization of the composition as defined previously, and also to the parts obtained themselves.

(Meth)acrylic resins are often used for making molded or cast objects, with or without filler, and also composites. In this case, the composition containing the mixture of (meth)acrylic monomers and optionally of (meth)acrylic polymers in the presence of polymerization initiators may be poured into a mold and then polymerized and hardened during a more or less gradual temperature increase. Once the polymerization is finished, a resin is obtained, which can then undergo different types of treatment depending on the desired applications. As a variant, the composition may just as well be poured between two molds, so as to recover, after polymerization, the corresponding resin. The polymerization is conventionally performed using radical initiators such as azo compounds, or alternatively organic peroxides. Azo initiators, of which the most common, AIBN, is solid, have evolutions of nitrogen which may be undesirable in films or transparent plates and are liable to release highly toxic decomposition products. Furthermore, they must be stored at a controlled temperature.

Moreover, organic peroxides, which are regularly used as polymerization initiators, are species which are generally highly unstable when they are heated. Indeed, in the event of uncontrolled temperature increase, some organic peroxides may undergo autoaccelerated exothermic decomposition, and risk igniting and/or violently exploding. Such behavior is thus difficult to reconcile notably with the rules in force as regards the transportation and storage of hazardous materials in places intended for the production of resins.

In order to reduce their thermal instability so as to be able subsequently to store and transport them safely, it is common practice to formulate organic peroxides in liquid form in solvents (also known as phlegmatizers), i.e. in diluted form. However, this has the consequence of degrading the optical and mechanical qualities of the products recovered after polymerization. Indeed, these products have the drawback of introducing, for safety reasons, a third non-polymerizable substance into the radical polymerization of the (meth)acrylic monomers, thereby increasing the risks of heterogeneity in the polymer finally obtained.

Moreover, the use of “cold peroxides” (that is to say that they have, alone or as a mixture with other peroxides and/or phlegmatizers, whether reactive or unreactive, a maximum cargo temperature, also referred to as the control temperature, set at 20° C. in accordance with the United Nations (UN) recommendations on the transportation of hazardous goods, 19th edition, 2015, in section 2.5.3.2.4 which relates to organic peroxides) still involves an excessively high risk of uncontrolled decomposition on storage and transportation in the event of an uncontrolled temperature increase.

More generally, for the purposes of the present invention, the term “cold peroxide” means any peroxide-based composition having a maximum cargo temperature as defined above.

It has also been proposed to use aromatic peroxides of diacyl or perester type.

However, organic peroxides of this type, in particular benzoyl peroxide (BPO), induce significant yellowing of the products obtained. Furthermore, even when diluted to 50% in a solvent of ester type, BPO has the drawback of being solid. In addition, peresters also have the drawback of being poorly soluble in acrylic monomers and lead to products whose mechanical properties are deemed to be too poor.

Similarly, alkyl hydroxyperoxides, such as tert-butyl hydroperoxide, have also been envisaged.

However, such peroxides have the drawback of generating free radicals at temperatures which are too high to effectively perform the radical polymerization of the (meth)acrylic monomers. Indeed, the half life temperature (HLT) of the alkyl hydroxyperoxides, i.e. the temperature at which half the amount of peroxide is decomposed in a given time for a decomposition time of the same order of magnitude as the duration of polymerization for the (meth)acrylic monomers, proves to be too high by several tens of degrees. In order to generate free radicals at lower temperatures, systems for chemical activation, such as ferrous ions, have been added, but they proved to be unsuitable due to the coloring induced in the polymer obtained, which has a negative impact on the optical quality of the products obtained. Furthermore, these activated hydroxyperoxide systems are difficult to dissolve in unsaturated monomers, in particular (meth)acrylic monomers.

The outcome of this is that conventional peroxides usually lead to products that have poorer mechanical and optical properties than those of products obtained with cold peroxides.

Thus, one of the aims of the present invention is to overcome the abovementioned drawbacks, that is to say to replace the organic peroxides commonly used during the radical polymerization of acrylic monomers with other polymerization initiators which are able to be entirely safely stored and transported alone or as a mixture, without degrading the optical and mechanical properties of the products obtained.

In other words, there is a real need to propose other polymerization initiators which are able to be stored and transported alone or as a mixture under temperature conditions strictly greater than 20° C., while still enabling the manufacture of products having good optical and mechanical properties, notably in terms of transparency, low coloration and wear.

### BRIEF DESCRIPTION OF THE INVENTION

Thus, the present invention relates to a composition comprising:

a) at least one (meth)acrylic polymer,
b) optionally at least one (meth)acrylic monomer, and
c) at least one organic peroxide chosen from hemiperoxyacetals,
d) at least one additional peroxide, preferably chosen from the group consisting of peroxyacetals.

The present invention also relates to a composition comprising:

a) at least one (meth)acrylic polymer,
b) optionally at least one (meth)acrylate monomer, and
c) at least one organic peroxide chosen from hemiperoxyacetals,
d) at least one additional peroxide, preferably chosen from the group consisting of peroxyacetals, said composition having a dynamic viscosity of between 10 mPa·s and 10 000 mPa·s at 25° C.

Hemiperoxyacetals have the advantage of having, alone or as a mixture with other peroxides and/or phlegmatizers, whether reactive or unreactive, a maximum cargo temperature, also referred to as the control temperature, strictly greater than 20° C. in accordance with the United Nations (UN) recommendations on the transportation of hazardous goods, 19th edition, 2015, in section 2.5.3.2.4 which relates to organic peroxides.

Thus, the use of hemiperoxyacetals alone or as a mixture makes it possible to improve the safety conditions in terms of transportation and storage relative to cold peroxides, as defined above.

In this way, the peroxides according to the invention are more readily handleable, in total safety, which makes it possible to significantly reduce costs associated with transportation and storage.

The hemiperoxyacetals also have the advantage of being able to be used alone, that is to say in undiluted form, which makes it possible, firstly, to dispense with the use of a non-polymerizable solvent, such as oils, imposed for safety reasons and liable to have a negative impact on the optical and mechanical qualities of the resins obtained and, secondly, to dispense with the use of a polymerizable solvent, such as an acrylic monomer, liable to increase the risks, on transportation or on storage, of an onset of polymerization which is not temperature-regulated.

More generally, the hemiperoxyacetals make it possible to dispense with the provision of any type of storage intended for the polymerizable or non-polymerizable solvent at the sites for production of peroxide (or of any device intended for storing a solvent), which leads to a significant space saving and to the reduction of the maintenance costs.

In other words, the peroxides according to the invention make it possible to overcome all sorts of problems associated with the use of polymerizable or non-polymerizable solvents.

More particularly, the peroxides according to the invention make it possible to dispense with the usual peroxide phlegmatizers such as hydrocarbons, for instance isododecane, mineral oils, esters such as liquid phthalates, and ethylbenzene.

Thus, the hemiperoxyacetals may be stored in a wider variety of containers or devices than the conventional, thermally unstable peroxides which are liable to decompose during an uncontrolled temperature increase.

Thus, the envisaged peroxides may initiate the polymerization of the (meth)acrylic monomers without necessarily needing to rely on systems intended to activate them chemically, such as ferrous ions, which avoids the risks of coloration of the resins.

Moreover, the products obtained, following polymerization of a composition comprising one or more (meth)acrylic monomers and/or (meth)acrylic polymers in the presence of one or more hemiperoxyacetals and of an additional peroxide, in particular a peroxyacetal, have good optical and mechanical properties.

In particular, the products obtained are transparent (in the absence of mineral filler), sparingly colored or even colorless, and are resistant to wear.

Other features and advantages of the invention will emerge more clearly on reading the description and the examples that follow.

For the purposes of the present invention, the term “composite” refers to a multicomponent material comprising several different phase domains, among which at least one type of phase domain is a continuous phase and in which at least one component is a polymer.

The abbreviation “phr” denotes parts per hundred parts of organic composition (i.e. the (meth)acrylic monomer and the optional (meth)acrylic polymer when the latter is present). For example, 1 phr of initiator in the composition means that 1 kg of initiator is added to 100 kg of organic composition.

The abbreviation “ppm” denotes parts by weight per million parts of organic composition. For example, 1000 ppm of a compound in the composition means that 0.1 kg of compound is present in 100 kg of organic composition (i.e. the (meth)acrylic monomer and the optional (meth)acrylic polymer when the latter is present).

For the purposes of the present invention, the term “weight sum of the (meth)acrylic monomer and of the optional (meth)acrylic polymer” means the weight of the (meth)acrylic monomer(s) when several different (meth)acrylic monomers are present, to which is added the weight of the (meth)acrylic polymer when the latter is present.

For the purposes of the present invention, the term “thermoplastic” means a non-crosslinked resin. A thermoplastic resin permits repair, remodeling and recycling relative to thermoset resins. Thus, a thermoplastic resin becomes liquid or less viscous when it is heated and may take new shapes by applying heat and pressure.

For the purposes of the present invention, the term “thermoset” refers to a crosslinked resin. Thus, the thermosetting resin, once hardened, retains a final shape.

For the purposes of the present invention, the term “thermosetting” refers to a resin that is capable of being crosslinked.

For the purposes of the present invention, the term “composite” refers to a macroscopic combination of two or more immiscible materials. The composite material consists of at least one material which forms the matrix, i.e. a continuous phase that ensures the cohesion of the structure, and of a reinforcing material. The purpose of using a composite material is to obtain performance qualities that cannot be obtained with each of its constituents when they are used separately. The composite material may be thermoplastic or thermoset, and is preferably thermoplastic.

For the purposes of the present invention, the term “between x and y” means that the upper and lower limits of this range are included, which is equivalent to at least x and up to and including y.

The expression “at least one” is equivalent to the expression “one or more”.

Organic Peroxide (Hemiperoxyacetal)

The at least one organic peroxide used in accordance with the present invention is chosen from the group consisting of hemiperoxyacetals.

The term “hemiperoxyacetal” means a compound of general formula (R₃)(R₄)C(—OR₁)(—OOR₂) in which:
R₁ represents a linear or branched, preferably C₁-C₁₂, preferably C₁-C₄, more preferably C1, alkyl group or a cycloalkyl group with R₂,
R₂ represents a linear or branched, preferably C₁-C₁₂, preferably C₄-C₁₂, and more preferably C₅, alkyl group, or represents a cycloalkyl group with R₁,
R₃ represents a hydrogen atom or a linear or branched, preferably C₁-C₁₂, more preferably C₄-C₁₂, alkyl group, or represents a cycloalkyl group with R₄,
R₄ represents a hydrogen atom or a linear or branched, preferably C₁-C₁₂, more preferably C₄-C₁₂, alkyl group, or represents a cycloalkyl group with R₃.

Preferably, R₃ forms a cycloalkyl group with R₄.

Preferably, when R₃ is a hydrogen atom, R₄ is a linear or branched, preferably C₁-C₁₂, more preferably C₄-C₁₂, alkyl group.

The organic peroxide is preferably chosen from the group consisting of hemiperoxyacetals having a half-life temperature at one minute and at atmospheric pressure ranging from 125° C. to 160° C., preferably ranging from 130° C. to 155° C. and more preferentially ranging from 140° C. to 150° C.

The term “half-life temperature at one minute” represents the temperature at which half of the organic peroxide has decomposed in one minute and at atmospheric pressure. Conventionally, the “half-life temperature at one minute” is measured in n-decane or n-dodecane.

The organic peroxide according to the invention is preferably chosen from the group consisting of the hemiperoxyacetals corresponding to the general formula (I) below:

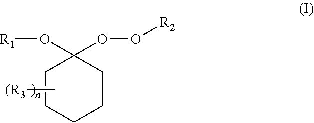

in which formula (I):
R₁ represents a linear or branched C₁-C₄, preferably C₁, alkyl group,
R₂ represents a branched C₄-C₁₂, preferably C₅, alkyl group,
n denotes zero or an integer ranging from 1 to 3,
R₃ represents a linear or branched C₁-C₃ alkyl group.

R₁ preferably represents a linear, more particularly C₁-C₂, more preferably C₁, alkyl group.

R₂ preferably represents a branched C₄-C₅, more preferably C₅, alkyl group.

Preferably n denotes zero.

R₃ preferably represents a linear or branched, C₁-C₂, more preferably C₁, alkyl group.

Preferentially, in formula (I), R₁ represents a linear or branched C₁-C₂ alkyl group, R₂ represents a branched C₄-C₅ alkyl group, and n denotes zero.

Even more preferentially, in formula (I), R₁ represents a C₁ alkyl group, R₂ represents a branched C₅ alkyl group and n denotes zero.

Preferably, the organic peroxide(s) are chosen from the group consisting of 1-methoxy-1-tert-amylperoxycyclohexane (TAPMC), 1-methoxy-1-t-butylperoxycyclohexane (TBPMC), 1-methoxy-1-t-amylperoxy-3,3,5-trimethylcyclohexane, 1-methoxy-1-t-butylperoxy-3,3,5-trimethylcyclohexane, 1-ethoxy-1-t-amylperoxycyclohexane, 1-ethoxy-1-t-butylperoxycyclohexane, 1-ethoxy-1-t-butyl-3,3,5-peroxycyclohexane and mixtures thereof.

Even more preferentially, the organic peroxide according to the invention is 1-methoxy-1-tert-amylperoxycyclohexane (TAPMC).

Advantageously, the hemiperoxyacetal(s) have a half life temperature at 10 hours, denoted HLT 10 h, of greater than or equal to 60° C. and less than or equal to 130° C.

Preferably, the content of organic peroxide is between 0.1 phr and 15 phr, preferably between 0.5 and 15 phr, preferably between 0.5 and 10 phr, more preferentially between 1 and 5 phr, more preferentially between 1.5 and 2.5 phr relative to the sum of the at least one (meth)acrylic monomer and of the optional at least one (meth)acrylic polymer.

The term “content of organic peroxide” means the sum of the content of hemiperoxyacetal and of additional organic peroxide(s).

Preferably, the weight ratio between the at least one hemiperoxyacetal and the at least one additional organic peroxide is between 99:1 and 30:70, preferably between 50:50 and 99:1, more preferentially between 80:20 and 99:1.

Additional Organic Peroxide(s)

The composition of the present invention comprises one or more distinct additional organic peroxides.

The term “distinct additional organic peroxide” means that the additional organic peroxide(s) are structurally distinct from the organic peroxide according to the invention chosen from the group of the hemiperoxyacetals as defined above.

Preferably, said additional peroxide(s) are chosen from the group consisting of the peroxyacetals.

More preferentially, the additional peroxide(s) are chosen from the group consisting of the peroxyacetals corresponding to the general formula (II) below:

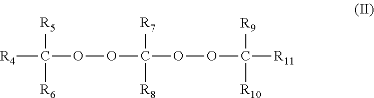

in which formula (II) R₄ to R₁₁, which may be identical or different, represent a linear, branched or cyclic C₁-C₆ alkyl group; preferably, R₇ and R₈ together form an optionally substituted ring; more preferentially, R₇ and R₈ together form an optionally substituted ring and R₄, R₅, R₆, R₉, R₁₀ and R₁₁ represent a linear, branched or cyclic C₁-C₆ alkyl group.

In a particularly preferred embodiment, the additional peroxide(s) are chosen from the group consisting of 1,1-di(tert-amylperoxy)cyclohexane, 1,1-di(tert-butylperoxy)-3,3,5-trimethylcyclohexane), 2,2-bis(4,4-di(tert-butylperoxy)cyclohexyl)propane, 1,1-di(tert-butylperoxy)cyclohexane and a mixture thereof, and is preferably 1,1-di(tert-amylperoxy)cyclohexane.

(Meth)Acrylic Monomer

For the purposes of the present invention, the term “monomer” means a molecule which can undergo polymerization.

For the purposes of the present invention, the term “at least one monomer” means that at least one monomer chemical species is present. In other words, the composition according to the invention comprises at least one (meth)acrylic monomer chemical species that is capable of polymerizing.

Preferably, the at least one (meth)acrylic monomer is chosen from the group consisting of acrylic acid, methacrylic acid, alkyl acrylic monomers, alkyl methacrylic monomers, hydroxyalkyl acrylic monomers and hydroxyalkyl methacrylic monomers, and mixtures thereof.

More preferentially, the at least one (meth)acrylic monomer is chosen from the group consisting of acrylic acid, methacrylic acid, alkyl acrylic monomers, alkyl methacrylic monomers, hydroxyalkyl acrylic monomers and hydroxyalkyl methacrylic monomers and mixtures thereof, the alkyl group containing from 1 to 22 linear, branched or cyclic carbons, preferably 1 to 12 linear, branched or cyclic carbons.

Advantageously, the at least one (meth)acrylic monomer is chosen from the group consisting of methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate, hydroxyethyl acrylate and hydroxyethyl methacrylate, and mixtures thereof.

Preferably, at least 50% by weight, preferably at least 60% by weight, preferably at least 70% by weight, advantageously at least 80% by weight and even more advantageously 90% by weight of the (meth)acrylic monomer is methyl methacrylate.

Preferably, the (meth)acrylic monomer is methyl methacrylate.

Preferably, the at least one (meth)acrylic monomer represents between 40% and 90% by weight, preferably between 45% and 85% by weight of the composition.

Advantageously, the composition according to the present invention comprises at least a second monomer comprising at least two (meth)acrylic functions.

Such monomers make it possible to obtain a thermosetting meth(acrylic) resin.

Preferably, said at least one second monomer represents between 0.01 and 10 phr, preferably between 0.1 and 5 phr by weight relative to the sum of the (meth)acrylic monomer and of the optional (meth)acrylic polymer.

Preferably, said second (meth)acrylic monomer is chosen from the group consisting of ethylene glycol dimethacrylate, neopentyl glycol diacrylate, neopentyl glycol dimethacrylate, 1,4-butanediol dimethacrylate, 1,4-butanediol diacrylate, 1,3-butylene glycol diacrylate, 1,3-butylene glycol dimethacrylate and a mixture thereof.

(Meth)Acrylic Polymer

The composition according to the present invention may comprise at least one (meth)acrylic polymer, preferably chosen from the group consisting of polyalkyl acrylates or polyalkyl methacrylates. Preferably, the (meth)acrylic polymer is poly(methyl methacrylate) (PMMA).

The term “PMMA” denotes a methyl methacrylate (MMA) homopolymer or copolymer or mixtures thereof.

Preferably, the methyl methacrylate (MMA) homo- or copolymer comprises at least 50%, preferably at least 70%, preferably at least 80%, advantageously at least 90% and more advantageously at least 95% by weight of methyl methacrylate.

Preferably, the PMMA is a mixture of at least one homopolymer and at least one copolymer of MMA, or a mixture of at least two homopolymers or two copolymers of MMA with a different average molecular weight or a mixture of at least two copolymers of MMA with a different monomer composition.

Preferably, the methyl methacrylate (MMA) copolymer comprises from 70% to 99.7% by weight of methyl methacrylate and from 0.3% to 30% by weight of at least one monomer containing at least one ethylenic unsaturation which may be copolymerized with methyl methacrylate.

These monomers are well known and mention may be made notably of acrylic and methacrylic acids and alkyl(meth)acrylates in which the alkyl group contains from 1 to 12 carbon atoms. As examples, mention may be made of methyl acrylate and ethyl, butyl or 2-ethylhexyl (meth)acrylate. Preferably, the comonomer is an alkyl acrylate in which the alkyl group contains from 1 to 4 carbon atoms.

According to a first preferred embodiment, the methyl methacrylate (MMA) copolymer comprises from 80% to 99.7%, advantageously from 90% to 99.7% and more advantageously from 90% to 99.5% by weight of methyl methacrylate and from 0.3% to 20%, advantageously from 0.3% to 10% and more advantageously from 0.5% to 10% by weight of at least one monomer, containing at least one ethylenic unsaturation, which may be copolymerized with the methyl methacrylate. Preferably, the comonomer is chosen from methyl acrylate and ethyl acrylate, and mixtures thereof.

Preferably, the average molecular weight of the (meth)acrylic polymer is greater than 50 000 g/mol and preferably greater than 100 000 g/mol.

The average molecular weight may be measured by exclusion chromatography (SEC).

Preferably, the (meth)acrylic polymer is completely soluble in the composition. This makes it possible to increase the viscosity of the composition.

Preferably, the at least one (meth)acrylic polymer represents at least 1% by weight, preferably at least 5% by weight and advantageously at least 10% by weight of the composition.

Preferably, the at least one (meth)acrylic polymer represents less than 50% by weight, preferably less than 40% and advantageously less than 30% by weight of the composition.

The addition of said at least one (meth)acrylic polymer to the composition of the present invention makes it possible to obtain a suitable dynamic viscosity for the composition. This dynamic viscosity makes it possible to retain the thermoplastic properties of the matrix obtained after polymerization and, where appropriate, good impregnation of the fibrous substrate.

Composition

The composition according to the invention makes it possible to afford, after polymerization, products having good optical and mechanical properties.

The composition according to the invention is therefore polymerizable or able to polymerize.

The dynamic viscosity of the composition of the present invention is preferably between 10 mPa·s and 10 000 mPa·s, preferably between 20 mPa·s and 7000 mPa·s and advantageously between 20 mPa·s and 5000 mPa·s and more advantageously between 20 mPa·s and 2000 mPa·s and even more advantageously between 20 mPa·s and 1000 mPa·s. The dynamic viscosity of the composition may be readily measured with a rheometer or a viscometer, preferably a Brookfield DV2LVTJ0 machine, using the standard ISO 2555. The dynamic viscosity is measured at 25° C. If the composition has Newtonian behavior, meaning no shear thinning takes place, the dynamic viscosity is independent of the shear in a rheometer or of the speed of the spindle in a viscometer. If the composition shows non-Newtonian behavior, i.e. meaning that shear-thinning takes place, the dynamic viscosity is measured at a shear rate of 1 s⁻¹ at 25° C.

The composition according to the present invention comprising at least one (meth)acrylic monomer and optionally at least one (meth)acrylic polymer, and at least one organic peroxide chosen from hemiperoxyacetals, is in liquid form if it contains no fillers. This composition is generally referred to as a “syrup” or “prepolymer”. The dynamic viscosity value of the liquid (meth)acrylic syrup is between 10 mPa·s and 10 000 mPa·s. The viscosity of the syrup can be readily measured with a rheometer or a viscometer. The dynamic viscosity is measured at 25° C.

Advantageously, the composition according to the present invention does not contain any deliberately-added additional solvent.

Stabilizers

The composition of the present invention may also comprise stabilizers (also known as reaction inhibitors). These stabilizers can prevent spontaneous polymerization of said at least one (meth)acrylic monomer.

These stabilizers may notably be chosen from hydroquinone (HQ), hydroquinone monomethyl ether (HQME), 2,6-di-tert-butyl-4-methylphenol (BHT), 2,6-di-tert-butyl-4-methoxyphenol (Topanol 0) and 2,4-dimethyl-6-tert-butylphenol (Topanol A).

Preferably, these stabilizers represent less than 5 parts by weight, advantageously less than 4 parts by weight and preferentially between 0.3 and 3 parts by weight, per 100 parts by weight of the at least one (meth)acrylic monomer and of the optional at least one (meth)acrylic polymer.

Mineral Filler

The (meth)acrylic composition according to the invention may also comprise a mineral filler.

The mineral filler may notably be chosen from the group consisting of quartz, granite, marble, feldspar, clay, glass, ceramics, mica, graphite, silicates, carbonates, carbides, sulfates, silicates, hydroxides, metal oxides, metals, aluminum trihydrate Al(OH)₃, and mixtures thereof.

Preferably, the mineral filler is in powder form.

Such a powder may be formed, for example, from particles, of which at least 50% by number have a mean particle size, noted as D50, of less than or equal to 50 μm, advantageously less than or equal to 20 μm and preferentially less than or equal to 5 μm. This value may be determined using a machine such as a Malvern Mastersizer.

Preferably, the sulfates are chosen from the group consisting of alkali metal and alkaline-earth metal sulfates, preferably magnesium sulfate, calcium sulfate, strontium sulfate and barium sulfate.

Preferably, the metal oxides are chosen from the group consisting of alumina Al₂O₃, which may or may not be hydrated, barium oxide BaO, silica SiO₂, magnesium oxide MgO and calcium oxide CaO. Preferably, the metal oxide is silica SiO₂. This silica may notably be a ground crystalline silica or an amorphous silica.

Preferably, the carbonates are chosen from the group consisting of calcium carbonate (chalk), magnesium carbonate, sodium carbonate and potassium carbonate.

Preferably, the silicates are chosen from the group consisting of calcium silicate, sodium silicate, potassium silicate and magnesium silicate.

The presence of aluminum trihydrate makes it possible in particular to improve the machining of the composite material obtained from the (meth)acrylic composition according to the invention and also the fire resistance properties of this material.

Preferably, the aluminum trihydrate is in the form of particles, of which at least 50% by number have a mean particle size, noted as D₅₀, of less than or equal to 50 μm, advantageously less than or equal to 20 μm and preferentially less than or equal to 5 μm.

Preferably, the (meth)acrylic composition according to the invention comprises less than 20 parts by weight of mineral filler, preferably less than 15, more preferentially less than 10, more preferentially less than 5, more preferentially less than 1 part by weight of mineral filler relative to the weight sum of the (meth)acrylic monomer and/or of the (meth)acrylic polymer of a mineral filler.

According to one embodiment of the invention, the composition comprises at least 0.1 part by weight, preferably at least 0.2 part by weight, more preferentially at least 0.5, more preferentially at least 0.8 part by weight of mineral filler relative to the weight sum of the (meth)acrylic monomer and/or of the (meth)acrylic polymer of a mineral filler.

According to one embodiment of the invention, the composition does not comprise any mineral filler. This allows the production of transparent resins.

Reinforcing Fibers

The composition according to the present invention may also comprise fibers.

For the purposes of the present invention, the fibers are not included in the definition of the mineral fillers defined above.

The fibers may be natural or synthetic. The fibers may be short or long.

Natural materials that may be mentioned include plant fibers, wood fibers, animal fibers or mineral fibers.

Natural fibers are, for example, sisal, jute, hemp, flax, cotton, coconut fibers, and banana fibers. Animal fibers are, for example, wool or fur.

Synthetic materials that may be mentioned include polymeric fibers chosen from fibers of thermosetting polymers, of thermoplastic polymers or mixtures thereof.

The polymeric fibers may consist of polyamide (aliphatic or aromatic), polyester, polyvinyl alcohol, polyolefins, polyurethanes, polyvinyl chloride, polyethylene, unsaturated polyesters, epoxy resins and vinyl esters.

The mineral fibers may also be chosen from glass fibers, in particular of type E, R or S2, carbon fibers, boron fibers or silica fibers.

Preferably, for the purposes of the present invention, the term “fibers” means a plurality of fibers, unidirectional rovings or a continuous filament mat, fabrics, felts or nonwovens which may be in the form of strips, webs, braids, strands or parts.

Preferably, the fibers have a length to diameter ratio of at least 1000, preferably at least 1500, more preferably at least 2000, advantageously at least 3000, more advantageously at least 5000, even more advantageously at least 6000, even more advantageously at least 7500 and most preferably at least 10 000.

Preferably, the (meth)acrylic composition according to the invention comprises less than 300 parts by weight of fibers, preferably less than 100, more preferentially less than 20, preferably less than 15, more preferentially less than 10, more preferentially less than 5, more preferentially less than 1 part by weight of mineral filler relative to the weight sum of the (meth)acrylic monomer and/or of the (meth)acrylic polymer.

According to one embodiment of the invention, the composition does not comprise any fiber. This allows the production of transparent resins.

Additives for Controlling the Exothermicity

The composition according to the present invention may comprise at least one additive for controlling the polymerization exothermicity, chosen from the group consisting of saturated short-chain aliphatic esters, short-chain glycols and diols, primary and secondary amines and mixtures thereof. These compounds make it possible to increase the heat dissipation, and thus to reduce the maximum polymerization exothermicity, reducing the amount of methyl methacrylate (MMA) monomer which boils and entrains air voids.

Preferably, said additive represents less than 6% by weight, preferably less than 5% by weight and preferably between 0.6% and 4% by weight relative to the weight of (meth)acrylic monomer and of the optional (meth)acrylic polymer. Such contents avoid having an impact on the reaction kinetics or the molecular weight. These compounds are particularly desirable on account of their low cost, their low toxicity and their minimal environmental impact. Furthermore, they are chemically inert under the polymerization conditions, which means that there is little or no effect on the curing time or the molecular weight of the product obtained.

Preferably, the saturated short-chain aliphatic esters are chosen from those containing C6-20 and preferably C8-12 carbon chains. It has been found that the heat dissipation effect reduces as the molecular size increases.

The saturated short-chain aliphatic esters that are useful comprise, for example, methyl heptanoate and methyl laurate.

The term “short-chain diol” means diols containing carbon chains of 2 to 6 and preferably of 3 or 4 carbons. Diols that may be mentioned include 1,3-butanediol and 1,4-butanediol. Glycols that may be mentioned include glycerol, 1,2-propylene glycol and 1,3-propylene glycol, diethylene glycol and Triton X-100 (C₁₄H₂₂O(C₂H₄O)ₙ) from Dow Chemical.

Preferably, the primary amines are chosen from primary amines containing linear and branched C4 to C20 aliphatic alkyl groups and aromatic primary amines.

Preferably, the aromatic primary amines are chosen from the group consisting of aniline and o-, m- and p-toluidines.

Preferably, the primary hydroxylamines are chosen from the group consisting of ethanolamine and 3-amino-1-propanol.

Preferably, the secondary amines are chosen from the group consisting of secondary diamines containing linear and branched C4 to C20 aliphatic alkyl groups and aromatic diamines.

Process for Preparing the Composition

The present invention also relates to a process for preparing the composition as defined above, comprising the following steps:

i) preparation of a mixture of (meth)acrylic polymer and/or of (meth)acrylic monomer

ii) addition of at least one organic peroxide chosen from hemiperoxyacetals, and optionally up to 20 phr, relative to the weight sum of the (meth)acrylic monomer and of the (meth)acrylic polymer, of a mineral filler to the mixture prepared in step i).

Preferably, when a (meth)acrylic polymer is present, it is added to the (meth)acrylic monomers and dissolved.

Preferably, step ii) is performed at a temperature T_{add} of less than 50° C., more preferably less than 40° C., advantageously less than 30° C. and more advantageously less than 25° C.

Uses

The present invention also relates to the use of at least one organic peroxide chosen from the hemiperoxyacetals as defined above in combination with at least one additional organic peroxide as defined above for the polymerization of a composition comprising at least one (meth)acrylic monomer and an optional at least one (meth)acrylic polymer, in particular an optional at least one (meth)acrylic copolymer as defined above.

The present invention also relates to the use of the composition as defined above or prepared via the process as defined above, for manufacturing acrylic or methacrylic resins, in particular thermoplastic, thermoset or composite parts.

Manufacturing Process

The present invention also relates to a process for manufacturing thermoplastic, thermoset or composite parts, comprising the following steps:
i) optionally, a step of preparing a composition as defined above,
ii) optionally, placing the composition as defined above in a mold,
iii) polymerization of said composition.

Said process may be chosen in particular from the group consisting of vacuum-assisted resin infusion (VARI), extrusion by drawing, molding by casting (by gravity or by low-pressure injection), vacuum bag molding, pressure bag molding, autoclave molding, resin transfer molding (RTM) and variants thereof (HP-RTM, C-RTM, I-RTM), reaction-injection molding (RIM), reinforced reaction-injection molding (R-RIM) and variants thereof, press molding, compression molding, liquid compression molding (LCM) or sheet molding compound (SMC) molding or bulk molding compound (BMC) molding.

The mold may in particular be a closed mold or a bath.

The manufacturing process according to the invention may also comprise a postforming step iv). Preferably, this postforming step iv) is performed after the polymerization step iii). The term “postforming” means the bending and also the changing of the shape of the composite part.

The manufacturing process according to the invention may also comprise a step v) of welding, bonding or laminating.

In a particular embodiment, the process according to the invention may comprise a step of impregnating the fibrous substrate in a mold with the composition as defined above. Preferably, the impregnation step is performed during step ii) of placing the composition in a mold.

If the viscosity of the composition of the present invention at a given temperature is slightly too high for the impregnation step, it is possible to heat the composition slightly so as to obtain a more liquid composition for sufficient wetting and correct and complete impregnation of the fibrous substrate.

For the purposes of the present invention, the term “fibrous substrate” means a plurality of fibers, unidirectional rovings or a continuous filament mat, fabrics, felts or nonwovens which may be in the form of strips, webs, braids, strands or parts.

Preferably, the polymerization step is performed at a temperature of between 50° C. and 140° C., preferably between 50° C. and 130° C., preferably at a temperature of between 70° C. and 120° C., preferably at a temperature of between 90° C. and 110° C.

Parts Obtained

The invention also relates to a part obtained via the above manufacturing process.

Said part may be thermoplastic, thermoset or composite, preferably thermoplastic.

The part obtained may be postformed after the polymerization of the composition of the invention.

The part obtained may be welded, bonded or laminated.

Preferably, the part is chosen from the group consisting of: a motor vehicle part, a boat part, a bus part, a train part, a sports article, a plane or helicopter part, a space ship or rocket part, a photovoltaic module part, a material for construction or building, for example composite armatures, dowels and callipers for civil engineering and high-rise construction, a wind turbine part, for example a girder spar cap of a wind turbine blade, a furniture part, a construction or building part, a telephone or cellphone part, a computer or television part, or a printer or photocopier part.

The examples that follow serve to illustrate the invention without, however, being limiting in nature.

### EXAMPLES

Preparation of the Test Compositions

### 1) Composition a According to the Invention Comprising 1.8 Phr of a Hemiperoxyacetal and 0.2 Phr of Peroxyacetal

A liquid composition A is prepared by dissolving 20% by weight of the PMMA (BS520, an MMA copolymer comprising ethyl acrylate as comonomer) in 80% by weight of methyl methacrylate, which is stabilized with HQME (hydroquinone monomethyl ether).

3 g of peroxide system TAPMC+1,1-di(tert-amylperoxy)cyclohexane are added to 150 g of this liquid composition, and the whole is stirred for 1 minute.

### 2) Composition B According to the Invention Comprising 1.67 Phr of a Hemiperoxyacetal, 0.19 Phr of Peroxyacetal and 18.6 Phr of a Mineral Filler

11.5 g of PMMA beads are added to 150 g of a liquid composition A as prepared according to example 1. The mixture is stirred for 40 minutes at 40° C. using a heating magnetic stirrer.

30 g of quartz flour (mineral filler) and 3 g of peroxide system TAPMC+1,1-di(tert-amylperoxy)cyclohexane are then added to the mixture.

### 3) Composition C Comprising 2 Phr of an Organic Peroxide of Perester Type

3 g of Trigonox® 141 (2,5-dimethyl-2,5-bis(2-ethylhexanoylperoxy)hexane) are added to 150 g of a liquid composition A as prepared according to example 1, and the whole is mixed for 1 minute.

### 4) Composition D Comprising 1.86 Phr of an Organic Peroxide of Perester Type and 18.6 Phr of a Mineral Filler

11.5 g of PMMA beads are added to 150 g of a liquid composition A as prepared according to example 1. The mixture is stirred for 40 minutes at 40° C. using a heating magnetic stirrer.

30 g of quartz flour (mineral filler) and 3 g of Trigonox® 141 are then added to the mixture.

Preparation of the Experimental Assembly

Molds were made by means of two glass plates of 20 cm×20 cm×3.85 mm assembled in parallel by means of a transparent PVC bead joint with a diameter of 4.80 mm, and the ends of the joint were then welded to ensure the final leaktightness of the molds.

Test Procedure

A France brand XU112 programmable furnace was set at a temperature of 55° C. The molds filled with compositions A to D were left at this temperature until the polymerization of the compositions was complete. The furnace was then brought to a temperature of 90° C. and the molds were then heated at this temperature for 1 hour. The tensile tests were performed under the conditions presented in table 1 below:

TABLE 1
Preparation of the test specimens

| | |
|---|---|
| Chopping | Charly processor |

Test conditions

| | |
|---|---|
| Standard (No., type, date) | ISO527 type 5A; 5B |
| Temperature (° C.) | 23° C. |
| Force sensor (KN) | 50 kN |
| Working length (Lo) | 25 mm |
| Extensometer | Used for calculating the modulus |

Tensile Test Results

It is observed that the use of a peroxide system comprising a hemiperoxyacetal and a peroxyacetal offers tensile mechanical performance qualities that are higher than implementation under the same conditions but with an organic peroxide of perester type.

1-17. (canceled)

18. A composition comprising:
a) at least one (meth)acrylic monomer,
b) optionally at least one (meth)acrylic polymer, and
c) at least one organic peroxide selected from the group consisting of hemiperoxyacetals,
d) at least one additional peroxide selected from the group consisting of peroxyacetals, said composition having a dynamic viscosity of between 10 mPa·s and 10 000 mPa·s at 25° C.

19. The composition as claimed in claim 18, wherein the content of organic peroxide is between 0.1 phr and 15 phr, relative to the weight sum of the at least one (meth)acrylic monomer and of the optional at least one (meth)acrylic polymer.

20. The composition as claimed in claim 18, wherein the (meth)acrylic polymer comprises at least 50%, by weight of methyl methacrylate.

21. The composition as claimed in claim 18, wherein the peroxide is selected from the group consisting of hemiperoxyacetals having a half-life temperature at one minute and at atmospheric pressure ranging from 125° C. to 160° C.

22. The composition as claimed in claim 18, wherein the peroxide is selected from the group consisting of hemiperoxyacetals corresponding to the general formula (I) below: 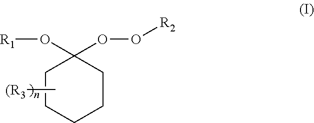
in which formula (I):
R1 represents a linear or branched C1-C4 alkyl group,
R2 represents a branched C4-C12 alkyl group,
n denotes zero or is an integer ranging from 1 to 3,
R3 represents a linear or branched C1-C3 alkyl group.

23. The composition as claimed in claim 18, wherein the peroxide(s) are selected from the group consisting of 1-methoxy-1-tert-amylperoxycyclohexane (TAPMC), 1-methoxy-1-t-butylperoxycyclohexane (TBPMC), 1-methoxy-1-t-amylperoxy-3,3,5-trimethylcyclohexane, 1-methoxy-1-t-butylperoxy-3,3,5-trimethylcyclohexane, 1-ethoxy-1-t-amylperoxycyclohexane, 1-ethoxy-1-t-butylperoxycyclohexane, 1-ethoxy-1-t-butyl-3,3,5-peroxycyclohexane and mixtures thereof.

24. The composition as claimed in claim 18, wherein the peroxide is 1-methoxy-1-tert-amylperoxycyclohexane.

25. The composition as claimed in claim 18, wherein said at least one additional peroxide is selected from the group consisting of the peroxyacetals corresponding to the general formula (II) below: 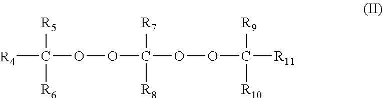
in which formula (II) R₄ to R₁₁, which may be identical or different, represent a linear, branched or cyclic C1-C6 alkyl group.

26. The composition as claimed in claim 18, wherein the additional peroxide(s) are selected from the group consisting of 1,1-di(tert-amylperoxy)cyclohexane, 1,1-di(tert-butylperoxy)-3,3,5-trimethylcyclohexane), 2,2-bis(4,4-di(tert-butylperoxy)cyclohexyl)propane and 1,1-di(tert-butylperoxy)cyclohexane and a mixture thereof.

27. The composition as claimed in claim 18, wherein the (meth)acrylic monomer is chosen from the group consisting of methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate, hydroxyethyl acrylate and hydroxyethyl methacrylate, and mixtures thereof.

28. The composition as claimed in claim 18, comprising up to 20 phr of a mineral filler, relative to the weight sum of the (meth)acrylic monomer and of the optional (meth)acrylic polymer.

29. A process for preparing a composition as claimed in claim 18, said process comprising the following steps:
i. preparation of a mixture of (meth)acrylic polymer and/or of (meth)acrylic monomer
ii. addition of at least one organic peroxide chosen from hemiperoxyacetals and of one or more distinct additional organic peroxides.

30. A process for manufacturing thermoplastic, thermoset or composite parts, comprising the following steps:
i) optionally, a step of preparing the composition of claim 18,
ii) placing the composition in a mold,
iii) polymerization of said composition.

31. The process as claimed in claim 30, wherein the polymerization step is performed at a temperature of between 50° C. and 140° C.

32. A part obtained via the process as claimed in claim 30.
